(19) United States
(12) Patent Application Publication
(10) Pub. No.: US 2023/0308241 A1
(43) Pub. Date: Sep. 28, 2023

(54) ENHANCED TRS

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN)

(21) Appl. No.: 18/041,501

(22) PCT Filed: Aug. 13, 2020
(86) PCT No.: PCT/CN2020/108852

§ 371 Date: Feb. 13, 2023

(51) Int. Cl. H04L 5/00; H04W 72/1273

(52) U.S. Cl. CPC H04L 5/0051; H04W 72/1273; H04B 7/0626

(57) ABSTRACT

Methods and apparatuses for configuring enhanced tracking reference signal are disclosed. In one embodiment, a method comprises transmitting a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

### FIELD

The subject matter disclosed herein generally relates to wireless communications, and more particularly relates to methods and apparatuses for configuring enhanced tracking reference signal (TRS).

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Orthogonal Frequency Division Multiplexing (OFDM), Radio Resource Control (RRC), Time-Division Duplex (TDD), Time Division Multiplex (TDM), User Entity/Equipment (Mobile Terminal) (UE), Uplink (UL), Universal Mobile Telecommunications System (UMTS), Physical Downlink Shared Channel (PDSCH), Physical Uplink Shared Channel (PUSCH), Physical Uplink Control Channel (PUCCH), Downlink control information (DCI), Single-DCI (S-DCI), transmission reception point (TRP), multiple TRP (multi-TRP or M-TRP), Quasi Co-Location (QCL), channel state information (CSI), channel state information reference signal (CSI-RS), Transmission Configuration Indication (TCI), reference signal (RS), Media Access Control (MAC), Control Element (CE), Demodulation Reference Signal (DM-RS), frequency range (FR), Non-Zero Power (NZP), Information Element (IE), tracking reference signal (TRS), remote radio head (RRH), resource element (RE), resource block (RB), beam management (BM), SS/PBCH block (SSB).

It is helpful for UE to improve the performance on channel estimation and demodulation if some large-scale properties (e.g. delay spread, Doppler spread, Doppler shift, and average delay) are known at the UE. The large-scale properties are measured by the UE based on certain reference signal(s). The accuracy of measurement of the large-scale properties largely depends on the density of the reference signal. For example, the measurement accuracy of Doppler shift and average delay depends on the frequency domain density and the time domain density, respectively. The measurement accuracy of Doppler spread, and delay spread depends on the time domain RE numbers and frequency domain RE numbers, respectively.

In NR, SSB can be used as a reference signal (RS) to measure channel properties. Since SSB has high density and large number of REs (resource elements) in an RB (resource block), accurate measurement results can be achieved if those parameters are measured based on the SSB signal. CSI-RS and DM-RS can also be used to measure channel properties. However, due to the low frequency domain density, CSI-RS and DM-RS cannot achieve good measurement performance, especially in situations of large frequency offset and high-speed movement. In NR Release 15, the UE obtains the fine Doppler shift, Doppler spread, average delay and delay spread by using the tracking RS (TRS), which is a type of CSI-RS with higher frequency domain density. An initial Doppler shift and average delay based on the measurement on SSB signal transmitted from the same TRP as that for TRS can be used by TRS according the configured QCL relationship between the TRS and the SSB.

The IE TCI-State associates one or two DL reference signals with a corresponding quasi-colocation (QCL) type as follows:

TCI-State information element

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The CSI-RS resource can be identified as a TRS resource by higher layer parameter trs-Info. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if a TCI-state is configured as TCI-state={CSI-RS #1, QCL-TypeA; CSI-RS #2, QCL-TypeD} and it is indicated for a PDSCH reception, it means that the DM-RS ports of the PDSCH can get the Doppler shift, Doppler spread, average delay, delay spread (i.e. QCL-TypeA parameters) from the estimation of CSI-RS #1 and the UE receives the PDSCH and the DM-RS port using the same spatial RX parameter (i.e. QCL-TypeD parameters) as that used to receive CSI-RS #2. It can be also expressed as: the DM-RS of PDSCH is QCLed with a CSI-RS #1 with QCL-TypeA, and is QCLed with a CSI-RS #2 with QCL-TypeD.

FIG. 1 illustrates the QCL chain for obtaining the large-scale properties in single-TRP scenario of NR Release 15. The UE can access the serving cell by SSB and obtain the initial Doppler shift and average delay (i.e. QCL-TypeC parameters) according to the SSB from which the UE obtains the MIB (Master Information Block). A TCI-state configured as TCI-state1={SSB, QCL-TypeC} can be indicated for TRS (i.e. NZP CSI-RS resource sets including NZP CSI-RS resources identified by configuring a higher layer parameter trs-Info as TRS). That is, the TRS can get the Doppler shift and average delay from the measurement of the synchronization signal in the associated SSB. Then, the UE can refine and track the Doppler shift, Doppler spread, average delay and delay spread by measuring the TRS. A TCI-state configured as TCI-state2={TRS, QCL-TypeA} can be indicated for any of CSI-RS for beam management (BM), CSI-RS for CSI acquisition, and DM-RS of PDCCH or PDSCH. That is, any of the CSI-RS for BM, the CSI-RS for CSI acquisition and the DM-RS of PDCCH or PDSCH can get QCL-TypeA: {Doppler shift, Doppler spread, average delay, delay spread} from the estimation of TRS.

The CSI-RS for CSI acquisition can be alternatively indicated with the TCI-state configured as TCI-state1={SSB, QCL-TypeC}, and get QCL-TypeC parameters: {Doppler shift, average delay} from the measurement of the synchronization signal in the associated SSB.

The above-described QCL chain illustrated in FIG. 1 may not apply to the intra-cell multi-TRP scenario as illustrated in FIG. 2. In FIG. 2, a UE is served by TRP #1 and TRP #2. For example, TRP #1 is a high power macro base station which has its own SSB signal, and TRP #2, that does not have SSB signal, is a low power remote radio head (RRH) connected with the high power macro base station TRP #1 via optical fiber. If UE mobility is large (e.g. for a high mobility UE), the frequency-offset and Doppler-shift differences between the two TRPs cannot be negligible. In such scenario, the estimation of QCL-TypeC parameter (especially the Doppler shift) of SSB from TRP #1 cannot be applied to the TRS from TRP #2. Since TRP #2 does not have a SSB resource, the UE cannot obtain the source QCL-TypeC parameter to receive the TRS from TRP #2.

Traditionally, the frequency domain density of the legacy TRS is set as ρ=3 REs per RB (each RB includes 12 REs in one symbol), and the time domain density of the legacy TRS is set as γ=2 in one slot. FIGS. 3 and 4 illustrate two examples of the legacy TRS.

In FIG. 3, the frequency domain density is set as ρ=3, and the time domain density is set as γ=2 in one slot (or γ=4 in two consecutive slots). That is, a UE in RRC connected mode is configured with one or more NZP CSI-RS resource sets configured with higher layer parameter ‘trs-info’ (which is used to identify the TRS) for frequency and timing tracking. Each set consists of 4 (γ=4) single port CSI-RS resources in two consecutive slots with 2 (γ=2) periodic CSI-RS resources in each slot. If no two consecutive slots are indicated as downlink slots, then each set consists of 2 (γ=2) periodic CSI-RS resources in one slot. The time-domain locations of the 2 CSI-RS resources in a slot has an interval of 4 OFDM symbols (e.g. l∈{4, 8}, l∈{5, 9}, l∈{6, 10} for frequency range 1 and frequency range 2), where l represents the symbol number (ranging from 0 to 13) of one slot. When ρ=3, REs with frequency domain locations k∈{k₀, k₀+4, k₀+8} can be used for the two resources in one slot in 12 subcarriers (e.g. k₀=0, 1, 2, 3), where k represents the subcarrier number (ranging from 0 to 11) of one carrier where the TRS is transmitted. FIG. 3 illustrates that l∈{4, 8} and k₀=2. In FIG. 3, the periodicity (Xp) of the periodic TRS is 10, which means that the TRS is configured in slot n and slot n+1, next in slot n+10 and slot n+11, and etc. If no two consecutive slots are indicated as downlink slots, the periodicity being 10 means that the TRS is configured in slot n, next in slot n+10, and etc.

In FIG. 4, the frequency domain density is set as ρ=3, and the time domain density is set as γ=2 in one slot. Each set consists of 2 (γ=2) periodic CSI-RS resources in one slot. The time-domain locations of the 2 CSI-RS resources in a slot has an interval of 4 OFDM symbols (e.g. l∈{4, 8}, l∈{5, 9}, l∈{6, 10} for frequency range 1 and frequency range 2). When ρ=3, REs with frequency domain locations k∈{k₀, k₀+4, k₀+8} can be used for the two resources in one slot in 12 subcarriers (e.g. k₀=0, 1, 2, 3). FIG. 4 illustrates that l∈{5, 9} and k₀=0. In FIG. 4, the periodicity (Xp) of the periodic TRS is 20, which means that the TRS is configured in slot n, next in slot n+20 and etc.

This invention aims to provide a solution for the UE to obtain QCL-TypeC parameter for the TRP without SSB signal in multi-TRP scenario.

### BRIEF SUMMARY

Methods and apparatuses for configuring enhanced tracking reference signal (TRS) are disclosed.

In one embodiment, a method comprises transmitting a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

In one embodiment, the time domain locations of the 4 CSI-RS resources in a slot is set as l∈{0, 4, 7, 11} or {1, 5, 8, 12} or {2, 6, 9, 13}, where l represents the symbol number in the slot. The periodicity of periodic enhanced TRS may be 5 slots.

In another embodiment, when the density ρ=3, the frequency domain locations of the 1^{st} and the 3^{rd} CSI-RS resources are set as k∈{k₀, k₀+4, k₀+8} in one RB, k₀=0 or 1, and the frequency domain locations of the 2^{nd} and the 4^{th} CSI-RS resources are set as k∈{k₀+2, k₀+6, k₀+10} in one RB, where k represents the subcarrier number of the carrier where the enhanced TRS is transmitted. Alternatively, when the density ρ=2, the frequency domain locations of the 1^{st} and the 3^{rd} CSI-RS resources are set as k∈{k₀, k₀+6} in one RB, k₀=0 or 1 or 2, and the frequency domain locations of the 2^{nd} and the 4^{th} CSI-RS resources are set as k∈{k₀+3, k₀+9} in one RB, where k represents the subcarrier number of the carrier where the enhanced TRS is transmitted.

In some embodiment, the enhanced TRS is configured as the QCL-TypeA RS for CSI-RS resource for beam management, or CSI-RS resource for CSI acquisition, or DM-RS of PDSCH or PDCCH. Moreover, the enhanced TRS is also configured as the QCL-TypeD RS for the CSI-RS resource for beam management, or the CSI-RS resource for CSI acquisition, or the DM-RS of PDSCH or PDCCH. Alternatively, the enhanced TRS is configured as the QCL-TypeC RS for CSI-RS resource for CSI acquisition.

In some embodiment, the method further comprises transmitting a configuration of one SSB of a serving cell associated with the enhanced TRS to obtain an initial average delay.

In another embodiment, a base unit comprises a transmitter that transmits a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

In one embodiment, a method comprises receiving a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

In yet another embodiment, a remote unit comprises a transmitter that transmits a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a QCL chain for obtaining the large-scale properties according to prior art;

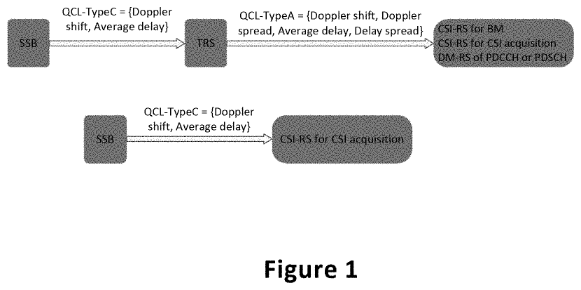

FIG. 2 illustrates an intra-cell multi-TRP scenario;

FIG. 3 illustrates a TRS pattern with l∈{4, 8}, ρ=3 and k₀=2;

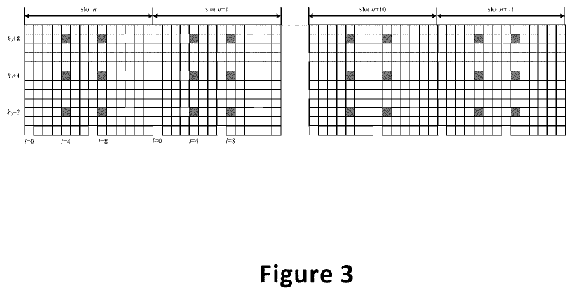

FIG. 4 illustrates a TRS pattern with l∈{5, 9}, ρ=3 and k₀=0;

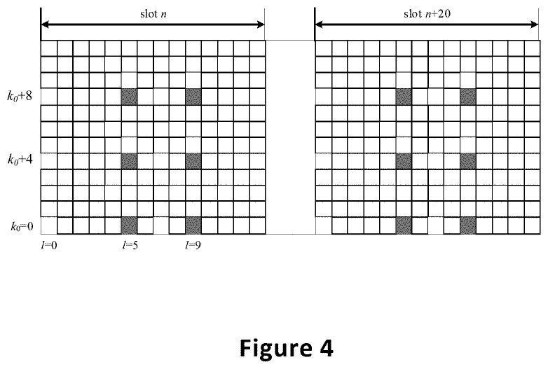

FIG. 5 illustrates an enhanced TRS pattern with l∈{0, 4, 7, 11}, ρ=3 and k₀=0;

FIG. 6 illustrates an enhanced TRS pattern with l∈{2, 6, 9, 13}, ρ=2 and k₀=0;

FIG. 7 illustrates an enhanced QCL chain with the configuration of E-TRS;

FIG. 8 is a schematic flow chart diagram illustrating an embodiment of a method;

FIG. 9 is a schematic flow chart diagram illustrating a further embodiment of a method; and

FIG. 10 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the FIGS. illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As the large-scale properties can be measured more accurately when the reference signal used for measuring has higher frequency domain density and/or higher time domain density, the present invention increases the frequency and time domain densities of the TRS.

As described in the background part, the frequency domain density of the legacy TRS is set as ρ=3 REs per RB, and the time domain density of the legacy TRS is set as γ=2 in one slot. It means that 6 REs in one RB in one slot can be used for TRS. The smallest periodicity is 10 slots for legacy TRS.

According to the present invention, an enhanced TRS is proposed. A UE in RRC connected mode can be configured with one or more NZP CSI-RS resource sets configured with higher layer parameter ‘trs-info-r17’ (which is used to identify the enhanced TRS) for frequency and timing tracking.

The configuration of the enhanced TRS can be as follows: up to 4 symbols in one slot can be used as the enhanced TRS, and the frequency domain locations in the 1^{st} used symbol can be different from that in the 2^{nd} used symbols to increase the equivalent frequency domain density. The periodicity (Xp) of the periodic enhanced TRS can be reduced to 5 slots. As a whole, the enhanced TRS (E-TRS) has increased frequency domain density and increased time domain density, so that it can be used by the UE to obtain an initial Doppler shift and average delay (i.e. QCL-TypeC parameter) of a TRP.

The detailed configuration of the enhanced TRS is described. For FR1 of 410 MHz to 7.125 GHz, each NZP CSI-RS resource set consists of 8 single port CSI-RS resources in two consecutive slots with 4 periodic CSI-RS resources in each slot. If no two consecutive slots are indicated as downlink slot, then each NZP CSI-RS resource set consists of 4 periodic CSI-RS resources in one slot. For FR2 of 24.25 GHz to 52.600 GHz, each NZP CSI-RS resource set consists of 4 periodic single port CSI-RS resources in one slot or consists of 8 single port CSI-RS resources in two consecutive slots with 4 periodic CSI-RS resources in each slot.

The time-domain locations of the 4 CSI-RS resources in a slot, or of the 8 CSI-RS resources in two consecutive slots (which are the same across two consecutive slots) can be set as l∈{0, 4, 7, 10, 11, 5, 8, 12}, {2, 6, 9, 13}, where l represents the symbol number (ranging from 0 to 13) of the slot.

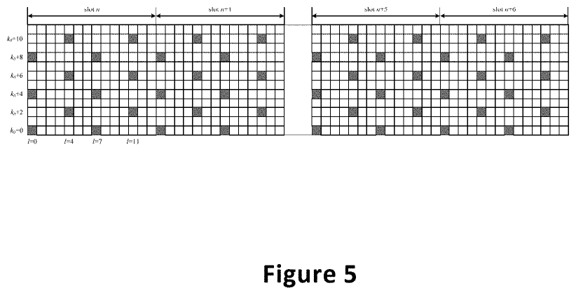

The frequency domain locations of the CSI-RS resources depend on value of the frequency domain density (p). When the density ρ=3, the frequency domain locations of the CSI-RS resources can be k∈{k₀, k₀+4, k₀+8} in one RB for the 1^{st} and the 3^{rd} CSI-RS resources in one slot of the configured SRS resource set, wherein k represents the subcarrier number (ranging from 0 to 11) of one carrier where the enhanced TRS is transmitted, k₀=0 or 1. The frequency domain locations of the CSI-RS resources can be k∈{k₀+2, k₀+6, k₀+10} in one RB for the 2^{nd} and the 4^{th} CSI-RS resources in one slot of the configured SRS resource set. In the above description, the n^{th} (n=1 to 4) CSI-RS resource in one slot refers to the CSI-RS resources in three (ρ=3) REs in one symbol (i.e. in one RB) of the one slot. The 1^{st} CSI-RS resource refers to the CSI-RS resources located in the first symbol of the one slot on which there exist CSI-RS resources, the 2^{nd} CSI-RS resource refers to the CSI-RS resources located in the second symbol of the one slot on which there exist CSI-RS resources, and etc. FIG. 5 illustrates an example of an enhanced TRS with l∈{0, 4, 7, 11}, ρ=3 and k₀=0. As the symbols on which there exist CSI-RS resources are the symbols “l=0”, “l=4”, “l=7” and “l=11”, the respective three (ρ=3) CSI-RS resources on the symbols “l=0”, “l=4”, “l=7” and “l=11” are referred to as the 1^{st} CSI-RS resource, the 2^{nd} CSI-RS resource, the 3^{rd} CSI-RS resource and the 4^{th} CSI-RS resource, respectively. It can be seen that the periodicity (Xp) of the periodic enhanced TRS is 5. That is, the TRS is configured in slot n and slot n+1, next in slot n+5 and slot n+6, and etc.

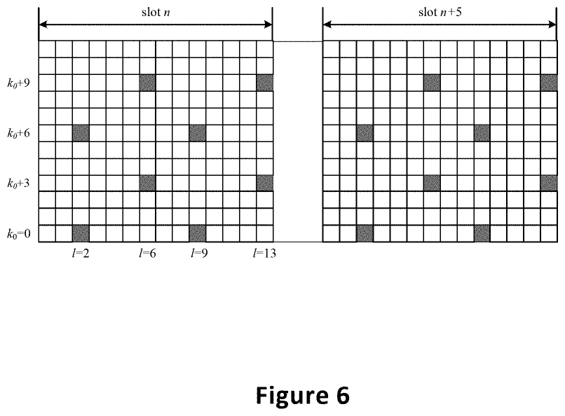

When the density ρ=2, the frequency domain locations of the CSI-RS resources can be k∈{k₀, k₀+6} in one RB for the 1^{st} and the 3^{rd} CSI-RS resources in one slot of the configured SRS resource set, wherein k₀=0 or 1 or 2. The frequency domain locations of the CSI-RS resources can be k∈{k₀+3, k₀+9} in one RB for the 2^{nd} and the 4^{th} CSI-RS resources in one slot of the configured SRS resource set. FIG. 6 illustrates an example of an enhanced TRS with l∈{2, 6, 9, 13}, ρ=2 and k₀=0. It can be seen that the periodicity (Xp) of the periodic enhanced TRS is also 5. That is, the TRS is configured in slot n, next in slot n+5, and etc.

The UE can obtain the initial Doppler shift and average delay (i.e. QCL-TypeC parameter) by using the configured E-TRS for the TRP without SSB.

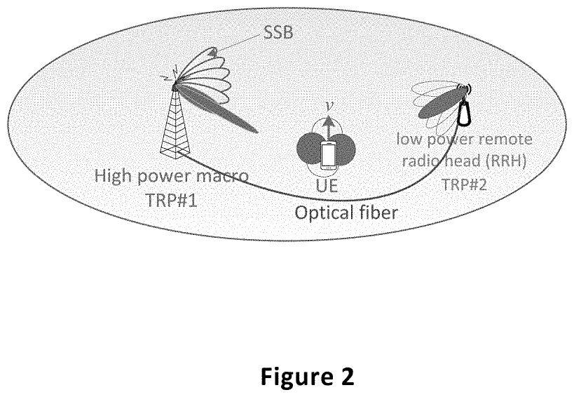

Preferably, with reference to FIG. 2, considering TRP #2 belongs to the coverage of TRP #1, one SSB from TRP #1 can be associated with the configured E-TRS from TRP #2, in view that the average delays for TRP #1 and TRP #2 can be assumed to be roughly the same. That is, the average delay from the estimation of the SSB from TRP #1 can be used as an initial average delay for the E-TRS from TRP #2. It can help the UE to use the E-TRS to obtain the fine average delay and to obtain the Doppler shift without blind detection.

If a new QCL-TypeE only containing average delay, i.e., ‘QCL-TypeE’: {Average delay}, is introduced, a TCI-state configured as {SSB, QCL-TypeE} can be indicated to the E-TRS.

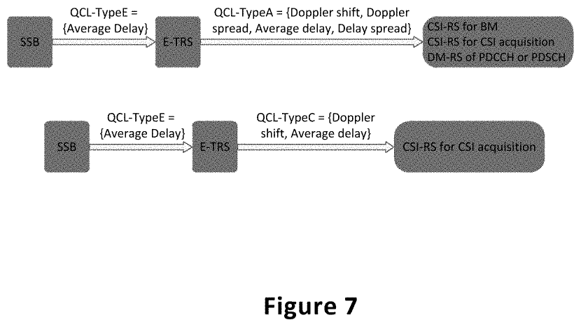

With the configuration of the E-TRS, an enhanced QCL chain is illustrated in FIG. 7.

For E-TRS, the UE expects that a TCI-state indicates QCL-TypeE with an SS/PBCH block (SSB). Preferably, when applicable, the UE expects that a TCI-state indicates QCL-TypeD with the same SS/PBCH block (SSB). The QCL-TypeE parameter (i.e. average delay) from SSB is not mandate. The E-TRS can be measured to obtain the QCL-TypeA parameters (i.e. Doppler shift, Doppler spread, average delay and delay spread) or QCL-TypeC parameters (i.e. Doppler shift and average delay) directly, (i.e. without an initial average delay from SSB).

For CSI-RS resource for beam management (BM), or CSI-RS resource for CSI acquisition, or DM-RS of PDSCH or PDCCH, the UE expects that a TCI-State indicates QCL-TypeA with an E-TRS. Preferably, when applicable, the UE expects that a TCI-state indicates QCL-TypeD with the same E-TRS.

Alternatively for CSI-RS resource for CSI acquisition, the UE expects that a TCI-state indicates QCL-TypeC with an E-TRS. Preferably, when applicable, the UE expects that a TCI-state indicates QCL-TypeD with the same E-TRS.

An example of the enhanced QCL chain is as follows. If a UE is configured with multi-DCI based multi-TRP transmission on a serving cell in the scenario illustrated in FIG. 2, TRP #2 does not have its own SSB. E-TRS can be configured for the UE to obtain the QCL-TypeA parameter for the DL signal from TRP #2. An SSB from TRP #1 is optionally associated with the E-TRS to obtain only the average delay. For example, the DM-RS of PDSCH or PDCCH for TRP #2 can be QCLed with an E-TRS from TRP #2 with QCL-TypeA (that is, to obtain the QCL-TypeA parameter for the reception of PDSCH or PDCCH transmitted from TRP #2), and the E-TRS for TRP #2 is optionally QCLed with a SSB from TRP #1 with QCL-TypeE.

From the point of view of the base unit (e.g. gNB), an E-TRS being configured means that a configuration of the E-TRS is transmitted (to the remote unit (e.g. UE)). From the point of view of the remote unit (e.g. UE), an E-TRS being configured means that a configuration of the E-TRS is received from the base unit (e.g. gNB).

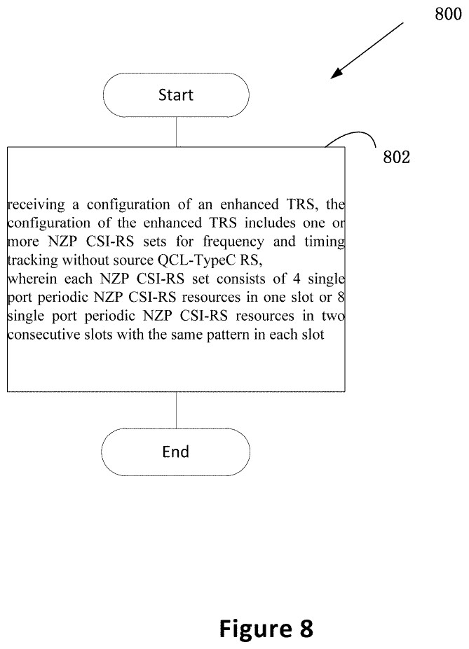

FIG. 8 is a schematic flow chart diagram illustrating an embodiment of a method 800 according to the present application. In some embodiments, the method 800 is performed by an apparatus, such as a remote unit. In certain embodiments, the method 800 may be performed by a processor executing program code, for example, a microcontroller, a microprocessor, a CPU, a GPU, an auxiliary processing unit, a FPGA, or the like.

The method 800 may include 802 receiving a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

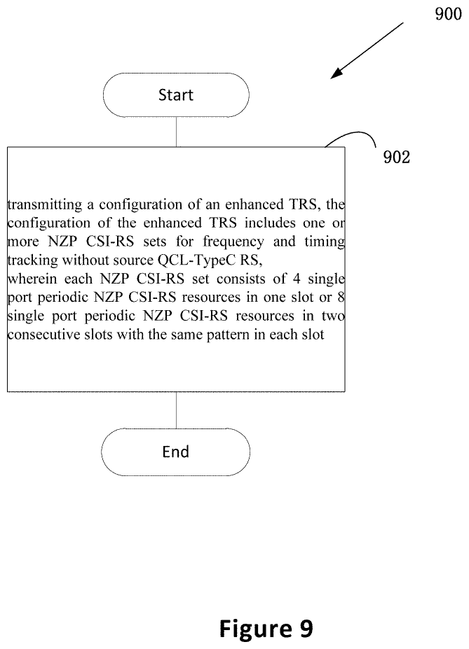

FIG. 9 is a schematic flow chart diagram illustrating an embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may include 902 transmitting a configuration of an enhanced TRS, the configuration of the enhanced TRS includes one or more NZP CSI-RS sets for frequency and timing tracking without source QCL-TypeC RS, wherein each NZP CSI-RS set consists of 4 single port periodic NZP CSI-RS resources in one slot or 8 single port periodic NZP CSI-RS resources in two consecutive slots with the same pattern in each slot.

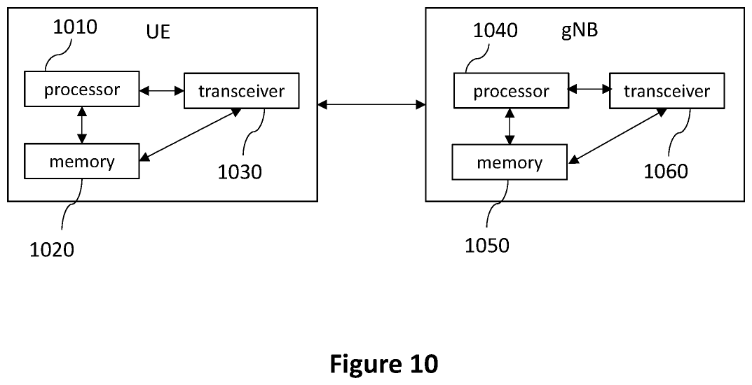

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 8. The gNB (i.e. base unit) includes a processor, a memory, and a transceiver. The processors implement a function, a process, and/or a method which are proposed in FIG. 9. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1-9. (canceled)

10. A base unit, comprising:
a transmitter that transmits a configuration of an enhanced tracking reference signal (TRS), the configuration of the enhanced TRS includes one or more Non-Zero Power (NZP) channel state information reference signal (CSI-RS) sets for frequency and timing tracking without source Quasi Co-Location (QCL)-TypeC reference signal (RS), wherein
each NZP CSI-RS set consists of 4 single port periodic NZP CSI-RS resources in one slot or 8 single port periodic NZP CSI-RS resources in two consecutive slots with the same pattern in each slot.

11. The base unit of claim 10, wherein, the time domain locations of the 4 CSI-RS resources in a slot is set as l∈{0, 4, 7, 11} or {1, 5, 8, 12} or {2, 6, 9, 13}, where l represents the symbol number in the slot.

12. The base unit of claim 10, wherein, the periodicity of periodic enhanced TRS is 5 slots.

13. The base unit of claim 10, wherein, when the density ρ=3, the frequency domain locations of the 1^{st} and the 3^{rd} CSI-RS resources are set as k∈{k₀, k₀+4, k₀+8} in one resource block (RB), k₀=0 or 1, and the frequency domain locations of the 2^{nd} and the 4^{th} CSI-RS resources are set as k∈{k₀+2, k₀+6, k₀+10} in one RB, where k represents the subcarrier number of the carrier where the enhanced TRS is transmitted.

14. The base unit of claim 10, wherein, when the density ρ=2, the frequency domain locations of the 1^{st} and the 3^{rd} CSI-RS resources are set as k∈{k₀, k₀+6} in one RB, k₀=0 or 1 or 2, and the frequency domain locations of the 2^{nd} and the 4^{th} CSI-RS resources are set as k∈{k₀+3, k₀+9} in one RB, where k represents the subcarrier number of the carrier where the enhanced TRS is transmitted.

15. The base unit of claim 10, wherein, the enhanced TRS is configured as the QCL-TypeA RS for CSI-RS resource for beam management, or CSI-RS resource for CSI acquisition, or Demodulation Reference Signal (DM-RS) of Physical Downlink Shared Channel (PDSCH) or Physical Uplink Control Channel (PDCCH).

16. The base unit of claim 15, wherein, the enhanced TRS is also configured as the QCL-TypeD RS for the CSI-RS resource for beam management, or the CSI-RS resource for CSI acquisition, or the DM-RS of PDSCH or PDCCH.

17. The base unit of claim 10, wherein, the enhanced TRS is configured as the QCL-TypeC RS for CSI-RS resource for CSI acquisition.

18. The base unit of claim 10, wherein, the transmitter further transmits a configuration of one SS/PBCH block (SSB) of a serving cell associated with the enhanced TRS to obtain an initial average delay.

19-27. (canceled)

28. A remote unit, comprising:
a transmitter that transmits a configuration of an enhanced tracking reference signal (TRS), the configuration of the enhanced TRS includes one or more Non-Zero Power (NZP) channel state information reference signal (CSI-RS) sets for frequency and timing tracking without source Quasi Co-Location (QCL)-TypeC reference signal (RS), wherein
each NZP CSI-RS set consists of 4 single port periodic NZP CSI-RS resources in one slot or 8 single port periodic NZP CSI-RS resources in two consecutive slots with the same pattern in each slot.

29. The remote unit of claim 28, wherein, the time domain locations of the 4 CSI-RS resources in a slot is set as l∈{0, 4, 7, 11} or {1, 5, 8, 12} or {2, 6, 9, 13}, where l represents the symbol number in the slot.

30. The remote unit of claim 28, wherein, the periodicity of periodic enhanced TRS is 5 slots.

31. The remote unit of claim 28, wherein, when the density ρ=3, the frequency domain locations of the 1^{st} and the 3^{rd} CSI-RS resources are set as k∈{k₀, k₀+4, k₀+8} in one RB, k₀=0 or 1, and the frequency domain locations of the 2^{nd} and the 4^{th} CSI-RS resources are set as k∈{k₀+2, k₀+6, k₀+10} in one RB, where k represents the subcarrier number of the carrier where the enhanced TRS is transmitted.

32. The remote unit of claim 28, wherein, when the density ρ=2, the frequency domain locations of the 1^{st} and the 3^{rd} CSI-RS resources are set as k∈{k₀, k₀+6} in one RB, k₀=0 or 1 or 2, and the frequency domain locations of the 2^{nd} and the 4^{th} CSI-RS resources are set as k∈{k₀+3, k₀+9} in one resource (RB), where k represents the subcarrier number of the carrier where the enhanced TRS is transmitted.

33. The remote unit of claim 28, wherein, the enhanced TRS is configured as the QCL-TypeA RS for CSI-RS resource for beam management, or CSI-RS resource for CSI acquisition, or Demodulation Reference Signal (DM-RS) of Physical Downlink Shared Channel (PDSCH) or Physical Uplink Control Channel (PDCCH).

34. The remote unit of claim 33, wherein, the enhanced TRS is also configured as the QCL-TypeD RS for the CSI-RS resource for beam management, or the CSI-RS resource for CSI acquisition, or the DM-RS of PDSCH or PDCCH.

35. The remote unit of claim 28, wherein, the enhanced TRS is configured as the QCL-TypeC RS for CSI-RS resource for CSI acquisition.

36. The remote unit of claim 28, wherein the receiver further receives a configuration of one SS/PBCH block (SSB) of a serving cell associated with the enhanced TRS to obtain an initial average delay.

37. A method, comprising:
transmitting a configuration of an enhanced tracking reference signal (TRS), the configuration of the enhanced TRS including one or more Non-Zero Power (NZP) channel state information reference signal (CSI-RS) sets for frequency and timing tracking without source Quasi Co-Location (QCL)-TypeC reference signal (RS);
wherein each NZP CSI-RS set consists of 4 single port periodic NZP CSI-RS resources in one slot or 8 single port periodic NZP CSI-RS resources in two consecutive slots with the same pattern in each slot.

38. The method of claim 37, wherein, the time domain locations of the 4 CSI-RS resources in a slot is set as l∈{0, 4, 7, 11} or {1, 5, 8, 12} or {2, 6, 9, 13}, where l represents the symbol number in the slot.
